(19) United States
(12) Patent Application Publication
(10) Pub. No.: US 2008/0270260 A1
(43) Pub. Date: Oct. 30, 2008

(54) CONTENT REQUEST, STORAGE AND/OR CONFIGURATION SYSTEMS AND METHODS

(75) Inventors: Dorrian Grant Porter, Menlo Park, CA (US); Andrew William Stack, Redwood City, CA (US); Adrian Jeremy Tymes, Mountain View, CA (US)

Correspondence Address: AMIN, TUROCY & CALVIN, LLP, 1900 EAST 9TH STREET, NATIONAL CITY CENTER, 24TH FLOOR,, CLEVELAND, OH, 44114, US

(73) Assignee: MOZES INCORPORATED, Palo Alto, CA (US)

(21) Appl. No.: 12/170,140

(22) Filed: Jul. 9, 2008

Related U.S. Application Data
(62) Division of application No. 11/397,195, filed on Apr. 4, 2006.

(51) Int. Cl. G06Q 30/00

(52) U.S. Cl. 705/26

(57) ABSTRACT

A content request, storage, and configuration system is provided which associates pieces of content with one or more keywords, and configures the content for the benefit of a user. Users load content into the system or link content elsewhere to the system, and optionally designate a set of actions to be taken. Keywords are assigned to the content and actions by the system based on user input and/or auto-generation by the system. Any of a variety of methods, including but not limited to Short Message Service (SMS) and instant messaging, are used by a user to communicate these keywords to the system, to indicate user interest in the associated content. Receipt by the system of the keywords from the user triggers the system to retrieve the relevant pieces of content, associate said content with the user making the request, and to take the designated actions if appropriate. In addition, users may designate that the system retrieve the relevant pieces of content and associate said content with other users.

### CROSS REFERENCE TO RELATED APPLICATIONS

This application is a divisional of U.S. patent application Ser. No. 11/397,195, filed on Apr. 4, 2006, entitled “CONTENT REQUEST, STORAGE AND/OR CONFIGURATION SYSTEMS AND METHODS”, the entirety of which is incorporated herein by reference.

### FIELD OF THE INVENTION

The present invention relates to systems and methods for content management that include use of a system and/or a set of services that assign one or more keywords and/or passwords to content, e.g., through the use of tags, to achieve any of storage, configuration, retrieval or other action by an owner of the content and/or the user.

### BACKGROUND

The explosive growth in digital content and e-commerce in the nineties and the present decade has been accompanied by a number of systems and corresponding processes for storing, managing and retrieving content in various electronic formats and in a variety of ways. Storing and managing all types of content, including documents, images, video, audio and the like, typically occurs inside of a content management application incorporating some type of a database, and which may be operated in a private network or on the Internet. With existing systems, retrieving the digital content from oneself or another content owner typically requires a person either to search for a document on a personal computer, a private network or the Internet, or to provide contact information (an Internet address, email address or instant message identifier) to the content owner so that the digital content can be delivered, received and enjoyed by that person.

Likewise, commercial transactions on the Internet or over the phone typically occur in one-to-one setting in which a buyer must conduct a transaction on a seller's own website or by speaking to a live operator. When doing so, the buyer must enter, re-enter or store a significant amount of personal information. Moreover, when a consumer sees something outside the Internet, like a seller's offline advertisement (such as a billboard, magazine or elsewhere), the consumer must almost always visit the Internet, place a voice telephone call, or visit a seller's physical site. In many cases the buyer is repeatedly shopping from the same seller and repeating many of the same time-consuming steps to conduct a transaction.

At the same time as the amount of content and e-commerce expands dramatically, people are increasingly relying on mobile devices as a primary means to communicate via voice, text, Internet enabled browsers or Internet enabled services like instant messaging. It can be appreciated that mobile devices are generally used because they are portable and convenient, and they are becoming near ubiquitous in their adoption by people all over the world. Yet, mobile devices, such as mobile phones, are often limited in their ability to navigate, retrieve and act on content or other data due to their portability, and corresponding limited input interface and storage capacities. With the enormous growth in both content availability and e-commerce, there is thus an emerging need on the part of content owners and commerce providers to obtain the content or conduct a transaction in a more simple, convenient, accurate and cost effective way.

Some existing services seek to connect requests for digital content or data to the direct delivery of content or data to the mobile device for immediate use or action, which the user may or may not be ready to take. Thus, there is an inherent disconnect in such systems between what the user may want and the ultimate timing of the delivery of the content by the content owner. In addition, these services lack an efficient way to communicate a request for specific information about which the user has just learned. Two main problems thus present themselves with respect to such existing systems. First, such systems are inefficient because they are overloaded with unwanted or irrelevant amounts of digital content or data. Second, such systems are dramatically limited in terms of the actions that a user may take with respect to such digital content or data.

Additionally, today's user interfaces that are presented to users on most mobile devices are not adequate for easy and complete free form text entries. Most mobile devices have a twelve digit number pad which is cumbersome to the user when the user is faced with typing in text like web addresses, email addresses, or other contact information. Consequently, mobile users have difficulty capturing information quickly and completely in a text form on their mobile device. In turn, passing relevant information from the user's mobile phone along to friends or other contacts is not easy and similarly, taking other action with respect to the information, such as buying a physical or digital product or service, is a difficult process if such other action is even possible for the user.

Thus, there is a need for an improved method for (a) a user to request and obtain digital content or data in which the user knows she is interested, (b) to store the requested digital content or data for immediate or later access by the user, and (c) to allow the user to take immediate or later action against the digital content or data. Likewise, owners of the digital content or data are currently in need of improved ways to track requests for, and use of, such digital content or data. Further, owners of digital content or data are in need of ways to enable new methods for having targeted users take action against such digital content or data in ways that make more sense for users. These and other disadvantages of existing content management systems have thus led to an overall need for a new architecture for managing content that better aligns the interests of content owners with the interests of content consumers, and vice versa.

### SUMMARY OF THE INVENTION

The present invention provides systems and methods for requesting, receiving and/or managing digital content or data, and for taking certain types of action in connection with or with respect to the digital content or data. In various non-limiting embodiments described herein, the system matches sets of digital content or data to unique keywords. The user of a portable device can use the portable device's existing communication capabilities to send a keyword to the system's request server. The keywords are then referenced in a database to identify the digital content or data associated with the keywords. The system retrieves the associated digital content or data from a database and stores it for immediate or later viewing or for use in performing some other action designated by the user. Based on the keywords and the identity of the user, the system may also configure the digital content or data in a particular way for that user to provide a custom content experience, or enable one or more particular actions to be taken with respect to the digital content or data. Exemplary non-limiting actions for the content that may be enabled for a user include, for instance, sharing content with friend(s) or group(s) of friends, enabling purchase of item(s) via a convenient network communication protocol, such as Short Message Service (SMS) messaging, or the like.

Other features of the invention are described in more detail below.

### BRIEF DESCRIPTION OF THE DRAWINGS

The content request, storage and configuration systems in accordance with the invention are further described with reference to the accompanying drawings in which:

FIG. 1 illustrates a system level block diagram of the content management system of the present invention;

FIG. 2 illustrates a system level block diagram showing storage relationships of the system from keywords to content or content links to content owners in accordance with the invention;

FIG. 3 illustrates exemplary aspects of keyword utilization and storage in accordance with the invention;

FIG. 4 illustrates an exemplary non-limiting flow diagram of keyword/content association methods of the present invention;

FIG. 5 illustrates an exemplary non-limiting flow diagram showing user interactions with content according to retrieval and configuration aspects of the invention;

FIG. 6 illustrates an exemplary non-limiting flow diagram showing content retrieval via keyword processes enabled by the content management systems or services of the invention;

FIG. 7 illustrates an exemplary non-limiting flow diagram showing purchasing processes enabled by the content management systems or services of the invention;

FIG. 8 illustrates an exemplary non-limiting flow diagram showing group sharing processes enabled by the content management systems or services of the invention;

FIG. 9A illustrates an overview of a network environment suitable for service by embodiments of the invention;

FIG. 9B illustrates a GPRS network architecture that may incorporate various aspects of the invention; and

FIG. 9C illustrates an alternate block diagram of an exemplary GSM/GPRS/IP multimedia network architecture in which the invention may be employed.

### DETAILED DESCRIPTION OF ILLUSTRATIVE EMBODIMENTS

### Overview

In consideration of the shortcomings of existing systems described above in the background, a content request, storage and configuration system is provided in accordance with the invention which loads and stores different types of content, associates each piece of content with one or more keywords and configures the content in particular ways for the benefit of a user. Content owners load content into the system or reference (e.g., link to) content from elsewhere, and keywords are assigned to the content by the system based on user input and/or auto-generation acts taken by the system.

In various exemplary non-limiting embodiments, a tag representing the keywords is associated with the content and stored in the system. Short Message Service (SMS), email, instant messaging, a designated entry point on a personal computer or mobile web browser, or other methods may be used by a user to communicate the one or more pre-assigned keywords in order to indicate user interest in a particular content item or items. Receipt by the system of the keywords from the user initiates identification and retrieval of relevant piece(s) of content by the system, and association of the content with the user making the request. Then, if desired by the user or if otherwise appropriate, the system operates to configure a user's account to take specific actions with respect to the content.

The user may also assign his or her own keywords to aid in the use of the system, and establish pre-defined additional actions that the system may take based on receipt of the keyword by the user. In one non-limiting embodiment, a user can send a request to purchase a particular content item or items with the use of keywords, the system having been pre-configured to execute a purchase transaction upon receipt of such keywords. In another non-limiting embodiment, a user can configure the system so that the send, or transmission, of the keyword triggers the deposit of the associated content in the account of another user or accounts of a group of users, or otherwise authorizes the other user(s) to interact with the content in a specified way.

### Systems and Methods for Storing, Retrieving and Configuring Digital Content

Various embodiments in which the invention may be used are described below, but as can be appreciated by one of ordinary skill in the software and networking arts, other embodiments may be utilized and structural and functional modifications may be made without departing from the scope of the content management storage, retrieval and configuration techniques of the present invention.

The present invention is a method for requesting digital content or data via the use of keywords and a system capable of retrieving, storing and configuring digital content or data based on the keywords or identity of the user. As used herein, the term “digital content or data” includes any one or more text, audio, video, image and data files including, but not limited to, database information, information worker files, such as spreadsheet files, markup language documents, such as XML, or any combination of such digital content or data.

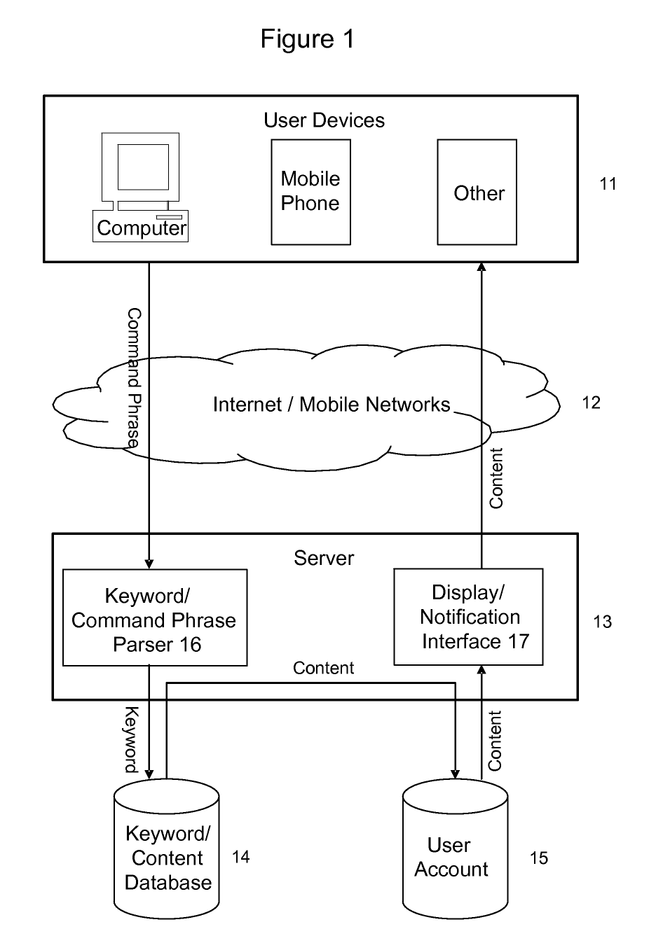

FIG. 1 is a diagram illustrating a system with an exemplary embodiment of the present invention. Other organizations will be known to those skilled in the art and also within the scope. There is no limit on the type of digital content or data that the invention can handle though the techniques may be tailored to types of files with respect to user action against the content. One can appreciate that digital content is created in and can be converted to many different formats and may be in varying sizes, and users will have a variety of different uses for particular digital content or data.

In FIG. 1, user devices 11, such as computers, mobile phones and/or other computer devices, comprise a first operational layer of the invention. For the avoidance of doubt, portable or mobile devices in accordance with the invention include a variety of computing devices including (a) portable media players, e.g., portable music players, such as MP3 players, walkmans, etc., (b) portable computing devices, such as laptops, personal digital assistants (“PDAs”), cell phones, portable email devices, thin clients, portable gaming devices, etc., (c) consumer electronic devices, such as TVs, DVD players, set top boxes, monitors, displays, etc., (d) public computing devices, such as kiosks, in-store music sampling devices, automated teller machines (ATMs), cash registers, etc., (e) navigation devices whether portable or installed in-vehicle and/or (f) non-conventional computing devices, such as kitchen appliances, motor vehicle controls (e.g., steering wheels), etc. Finally, while some embodiments are directed to systems and method for use in portable devices, as one of ordinary skill in the art can appreciate, the techniques of the invention are by no means limited to practice on portable devices, but may also apply to standalone computing devices, such as personal computers (“PCs”), server computers, gaming platforms (e.g., Xbox), mainframes, etc.

User devices 11 are communicatively coupled via networks 12 to a set of networked services 13 (which may be a centralized server, or distributed) which provide content storage, retrieval and configuration services in accordance with the invention. The server or services 13 include a keyword/command phrase parser 16 for receiving content and keywords from content owners and users for storage or retrieval of content in or from a keyword/content database 14, respectively, by the content management system of the invention. The server or services 13 also include a display/notification interface 17 for rendering or notifying designated recipients of content retrieved in accordance with the content management techniques of the invention. User account data is also stored in storage 15, which includes configuration data and other user information as part of the user's account with the content management system of the invention. The storage techniques of the invention may also invariably be implemented across a plurality of storage components, such as databases or other storage, which may be co-located, or distributed, and of the same type of storage, or disparate types.

In operation, as described in more detail below, user devices operate to send keywords and command phrases to keyword/command phrase parser 16 for the retrieval of content for designated action based on the command phrases. The keywords are checked against the keyword/content database 14 in order to retrieve at least one set of content based on the commands of the command phrase(s) received by parser 16. Then, prior to taking action on the content, user account data in storage 15 may be further consulted to determine if there are any additional parameters (e.g., other filters on the content) that should be applied to the retrieved content based on configuration information stored for the user in accordance with the invention. Next, interface 17 takes any designated actions as specified by the commands of the command phrase(s) with respect to the resulting set(s) of content matching the user keywords and user configuration data. For instance, interface 17 may prepare the resulting set(s) of content for display on a particular user device known to have a certain type of display, or known to handle certain formats of content, i.e., the resulting content is readied for rendering on the device. Or, for another example, interface 17 may send notifications to a group of friends about the content and about certain actions (e.g., purchase) that may optionally be taken with respect to the content. Finally, the content and/or notifications are delivered to the appropriate recipient (e.g., the user in the case of a request for display of content, or the group of friends in the case of the notification example).

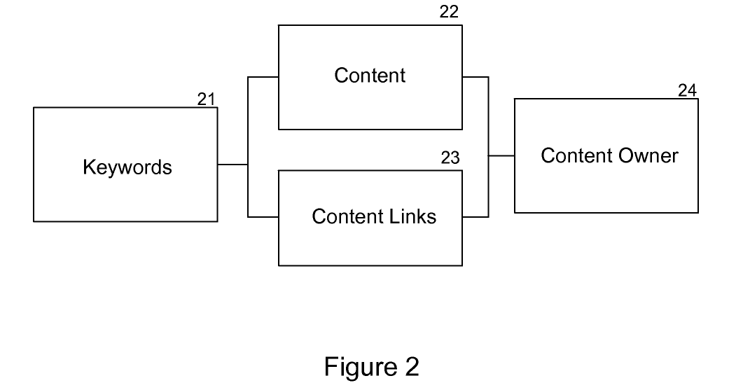

A number of tables are included in the database are depicted in FIG. 2. These tables are used to identify owners of digital content or data, to associate keywords with certain types of digital content or data and to assign certain available actions that might be available to take against the digital content or data. Tables are also used to manage the assignment of keywords to digital content or data to ensure that each set of digital content or data is assigned a unique keyword or keywords. Keywords 21 can be assigned to multiple content 22 and multiple content links 23. A content owner 24 can own multiple content 22 and multiple content links 23.

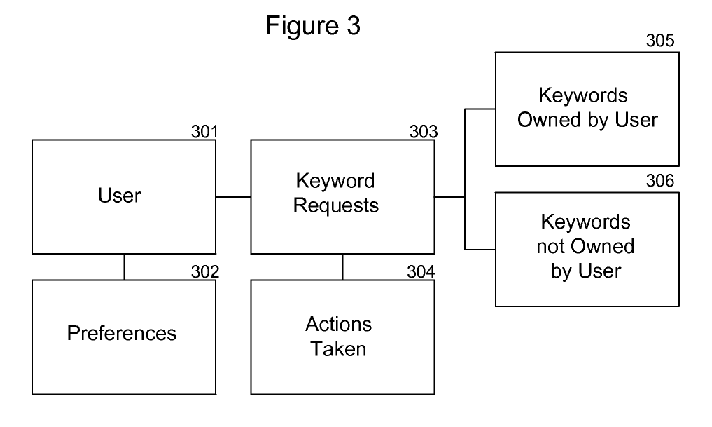

On the user side in FIG. 3, tables are used to identify a user 301 with the keyword requests 303, to store preferences 302 with respect to certain types of actions that may be taken against the digital content or data, and to record historical actions 304 actually taken by the user with respect to the digital content or data. From the user's perspective, their keyword requests 303 can be either of a keyword they own 305 or a keyword they do not own 306. The sum of 305 and 306 results in a Keyword table 21.

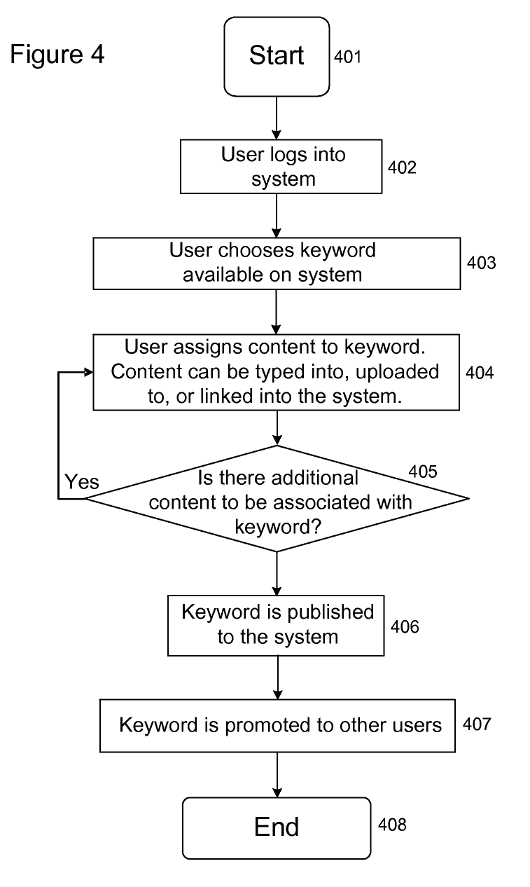

The owner of digital content or data can use the system to upload digital content or data, shown in FIG. 4. The user, starting at 401, then logs into the system at 402 and chooses a keyword that is currently available at 403. The user then assigns content to the keyword at 404 and determines if there is additional content to be associated with the keyword at 405. In one embodiment, the assignment of additional content that takes place at act 404 continues until the user is finished. The user then publishes the keyword at 406 to make it available for use. The keyword is then promoted to other users at 407, thereby ending the creation cycle of a keyword at 408. In addition, the owner of digital content or data may enable an integration point with the system that allows the system to retrieve the digital content or data from the owner on demand at the time it is required, and/or to take additional actions on demand. For instance, the system might signal a Web server under the control of the content owner to execute a script that the owner has designated, which script can execute any of a number of actions, for example real time queries, control over robotic systems, or registering a tally to be compared to the tallies recorded in response to other keywords. The owner may request the assignment of a keyword or keywords, or they will be assigned automatically, to the digital content or data. The database 14 depicted in FIG. 1 stores reference to the digital content, or interfaces to the digital or data, along side tags representing the associated keyword or keywords. Digital content or data can be grouped together and may include different types of content or variations of the same content. Groups of digital content or data may share the same keyword or keywords.

By establishing a method and system for owners of digital content and data to connect the digital content or data to keywords, a much improved means of locating digital content and data is realized. There are many circumstances in which it may be beneficial for a person to obtain digital content without searching for the content, disclosing one's identity to a third or being compelled to provide a unique place of delivery and receipt such as a physical mailing address, email or fax number. The ability for a user to request digital content with keywords meets the needs and interests of users because they can enable access to the content they want when they want it in a simple and convenient way, typically via a mobile device. It also helps meet the needs of content owners, commerce providers and other organizations looking to distribute digital content or data, or have actions taken against such digital content or data, because they know the persons requesting access are genuinely interested.

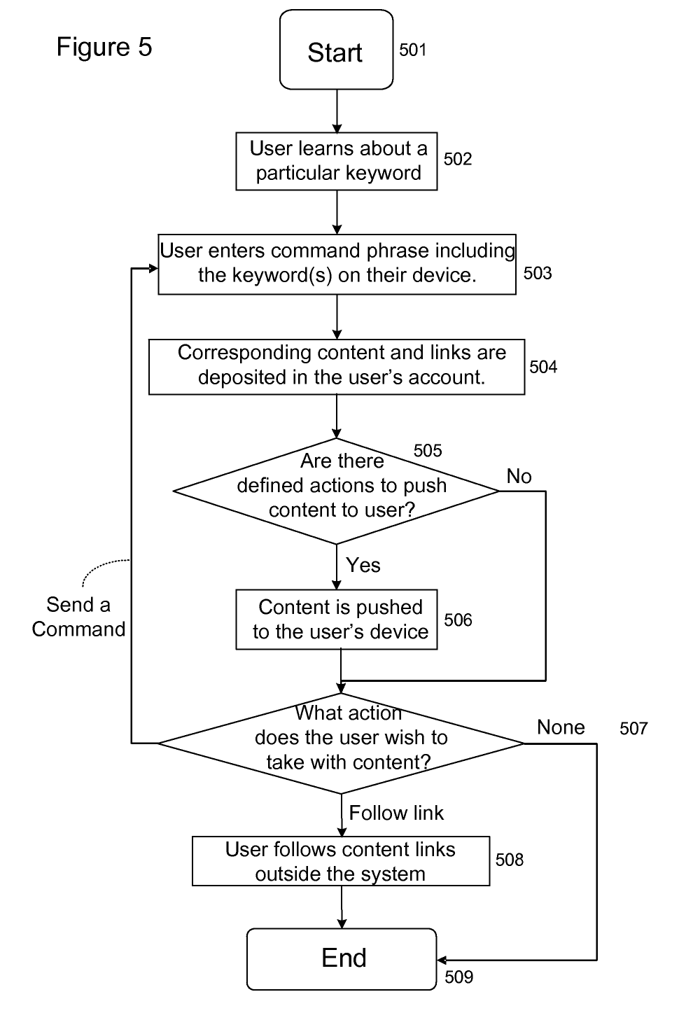

The typical user experience with the invention, shown in FIG. 5, starts with the mobile terminal at 501, although any computer may encompass the initiating source for delivery of the keywords by the user. A user will know to or be instructed to send specific keywords as a message to the server at 502. Once the user enters a command phrase, including a keyword, on their device at 503, the corresponding content and links are deposited into the user's account at 504. If there are predefined actions to push the content to the user at 505 then that content is pushed to the user's device at 506. The user decides what action to take with the content and links deposited in their account at 507 by either repeating the keyword and command phrase step returning to 503, taking no action thus ending the steps at 509, or following a content link given to them which will take them outside the system at 508.

In a preferred, but non-limiting, embodiment, the system is supported by an SMS mobile messaging platform that integrates with the multiple platforms of the cellular companies (or, for those cellular companies with an alternate preferred means of text messaging, to their equivalent of SMS), as well as a content management system. In this case, the request server receives an SMS (or equivalent) containing the keyword from a user and looks up the digital content or data that the user is requesting in the database. In another embodiment of the invention, the request server is reached through the use of an instant messaging (IM) system wherein the request server as a machine is reached as part of the IM's buddy list. In such an embodiment, the request server would appear as a buddy on the user's IM interface, which means that the user could initiate a text message conversation with the request server using the IM's existing capabilities. The user would send the keywords as a text message. In yet another embodiment, the user could use an entry field on a web based application that is directly connected to the system. In all cases, the system would realize the identity of the user, which information would be available to the system based on the method of communication selected.

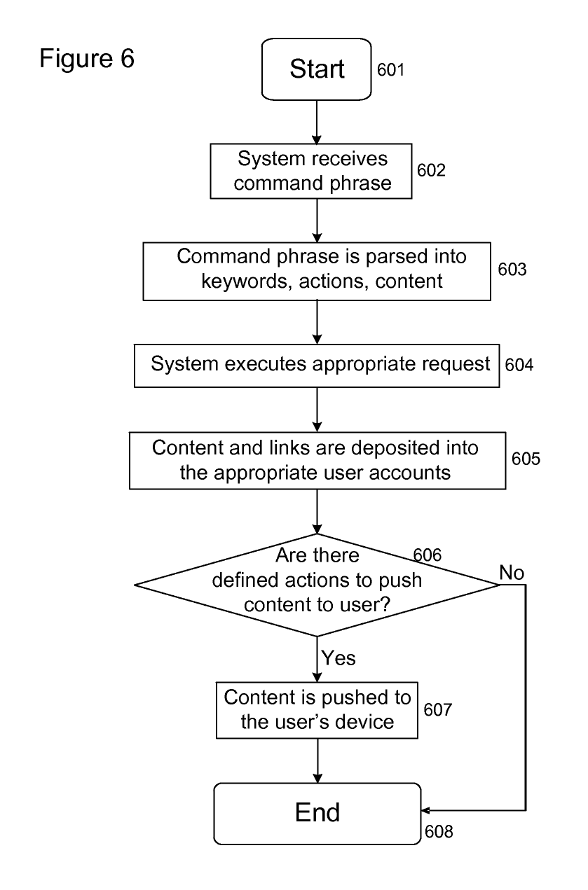

FIG. 6 shows the system flow of the keyword/content processing. The system begins at 601 and then receives a command phrase at 602. This command phrase is parsed into keywords, actions, and content at 603 by the system. The system then executes the appropriate request at 604 and content and/or link(s) are deposited into the appropriate user accounts at 605. If there are defined actions to push content to users at 606, then the content is pushed to the user(s)' device at 607; if not, the system process ends at 608.

Once the digital content or data is identified by its keywords, it can be presented to the user on a web-based application enabled by the system, which may be accessible via generally available web browsers on either personal computers or mobile devices. The manner in which digital content or data is displayed to the user is controlled by preferences of the owner of the digital content or data, the type of digital content or data, and the capabilities of the system. For example, a hyperlink to a url may appears as a hyperlink with brief summary information associated with the hyperlink appearing underneath. An audio file may appear only as a title of the audio file. A video may appear as a single digital image of one of the frames of the video with no title or description.

Depending on the type of digital content or data stored or integrated with system, certain actions may be available to take with respect to the content. For example, a user who is presented with the content by the system may be able to forward the content received directly to an email account or some other system. Sometimes a user may want to have the requested digital content or data delivered directly back to a mobile terminal. Other times, the user may want to have the digital content or data viewable in a web browser, or the original software application in which the digital content or data was meant to be viewed.

A user may also predefine a preference as to what to do with the digital content or data so that the system will take action with the digital content or data immediately. For example, if a user were requesting audio files from the same digital content owner repeatedly, and each time the user used the capabilities of the system to export the file to another system, the user may instead configure the system to automatically forward the audio file to another system or software application.

Digital content or data may also be configured by the system for other actions by the user. For example, the seller of shoes may enable a user to use the keyword “shoes” to deposit a hyperlink to the seller's website in the user's account for the user to obtain additional information on the particular shoes. In addition to the additional information, however, the system may also enable the user to buy the shoes without leaving the web based application, the system having configured the digital content or data to enable the ability to conduct an e-commerce transaction.

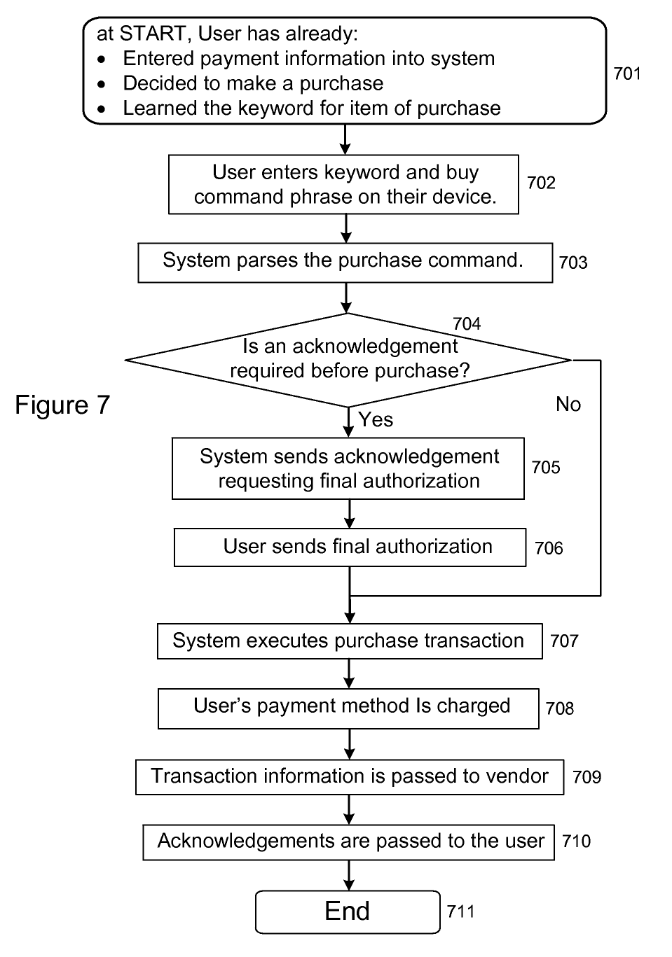

The system also supports actions that can be specified at the time of submitting the keyword, to have the system process those actions directly. One category of action is the purchase of an item represented by a keyword. FIG. 7 shows the action flow of such a scenario. Prior to making a purchase, the user has entered their personal payment information and preferences into the system, decided to make a purchase, and knows the keyword and command phrase for the item of interest at 701. When the user wants to purchase an item directly using the system, the user will enter the keyword and the buy command as one command phrase into the system at 702, the system parses the purchase request at 703 and determines if an acknowledgement is required in order to make the purchase at 704. If so, then the system responds with a confirmation request at 705, and when the user acknowledges the confirmation at 706, the system acts as a purchasing agent by executing the purchase transaction at 707, charging the user's payment method at 708, passing the purchase and payment information securely along to the vendor at 709, returning whatever acknowledgement or receipt is necessary to the user at 710, thus completing the process at 711. If no acknowledgement is required at 704, then the system jumps to execute the transaction at 707.

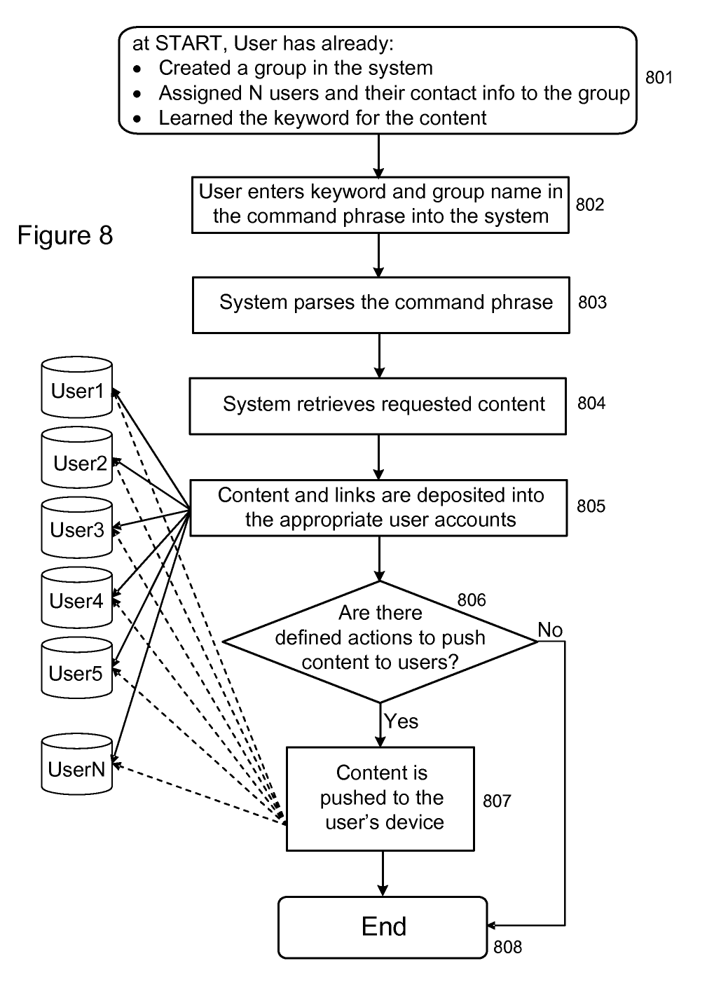

Another novel use of the system is in the quick and easy dissemination of content represented by keywords to another recipient or multiple other recipients. FIG. 8 shows this scenario. In one embodiment, the user can append the keyword with a short command followed by another person's phone number, or a name linked to a pre-established phone number, as a single command, and the system will create an account for the other person, notify the person of the account's existence and associate the content related to the keyword with the other person's account. Prior to sending a multiple-recipient message, the user has defined a group name, associated a list of members and their contact information with the group name, and learned the keyword for whatever content they wish to share at 801. When a user wants to pass information to multiple recipients, the user will enter the keyword and the group name in one command phrase into the system at 802. The system then parses the command phrase at 803 and retrieves the content associated with the keyword at 804 and automatically deposits the content response into the accounts or devices of all the members of the group at 805. If there are defined actions to push content to the users at 806, then the content is pushed to the device of each member of the group at 807; if not, then the process ends at 808.

By enabling a system that allows different groups to tag and manage digital content or data in a way that make it easier for other people to access, particularly in a mobile oriented world, the invention can save time, provide an improved means for privacy and reduce costs for the parties involved. The establishment of a central system (‘central’ from the standpoint of the users and content owners, though the services may be distributed and need not be a central set of servers) to manage and configure the requested digital content or data allows the user to rely on a single destination to manage multiple requests of multiple types of content from multiple content owners.

### Exemplary Non-Limiting Network and Operating Environments

The following description sets forth some exemplary networks and non-limiting operating environments for the systems and methods for content management of the present invention. The below-described operating environments should be considered non-exhaustive, however, and thus the below-described network architectures merely show how the services of the present invention may be incorporated into some exemplary existing network structures and architectures. One can appreciate, however, that the invention may be incorporated into now existing or future alternative architectures for communication networks as well, and to systems that encompass or integrate a plurality of disparate communication networks.

The global system for mobile communication (“GSM”) is one of the most widely utilized wireless access systems in today's fast growing communication systems. GSM provides circuit-switched data services to subscribers, such as mobile telephone or computer users. General Packet Radio Service (“GPRS”), which is an extension to GSM technology, introduces packet switching to GSM networks. GPRS uses a packet-based wireless communication technology to transfer high and low speed data and signaling in an efficient manner. GPRS optimizes the use of network and radio resources, thus enabling the cost effective and efficient use of GSM network resources for packet mode applications.

As one of ordinary skill in the art can appreciate, the exemplary GSM/GPRS environment and services described herein can also be extended to 3G services, such as Universal Mobile Telephone System (“UMTS”), Frequency Division Duplexing (“FDD”) and Time Division Duplexing (“TDD”), High Speed Packet Data Access (“HSPDA”), cdma2000 1x Evolution Data Optimized (“EVDO”), Code Division Multiple Access-2000 (“cdma2000 3x”), Time Division Synchronous Code Division Multiple Access (“TD-SCDMA”), Wideband Code Division Multiple Access (“WCDMA”), Enhanced Data GSM Environment (“EDGE”), International Mobile Telecommunications-2000 (“IMT-2000”), Digital Enhanced Cordless Telecommunications (“DECT”), etc., as well as to other network services that shall become available in time. In this regard, the techniques of the invention may be applied independently of the method of data transport, and do not depend on any particular network architecture, or underlying protocols.

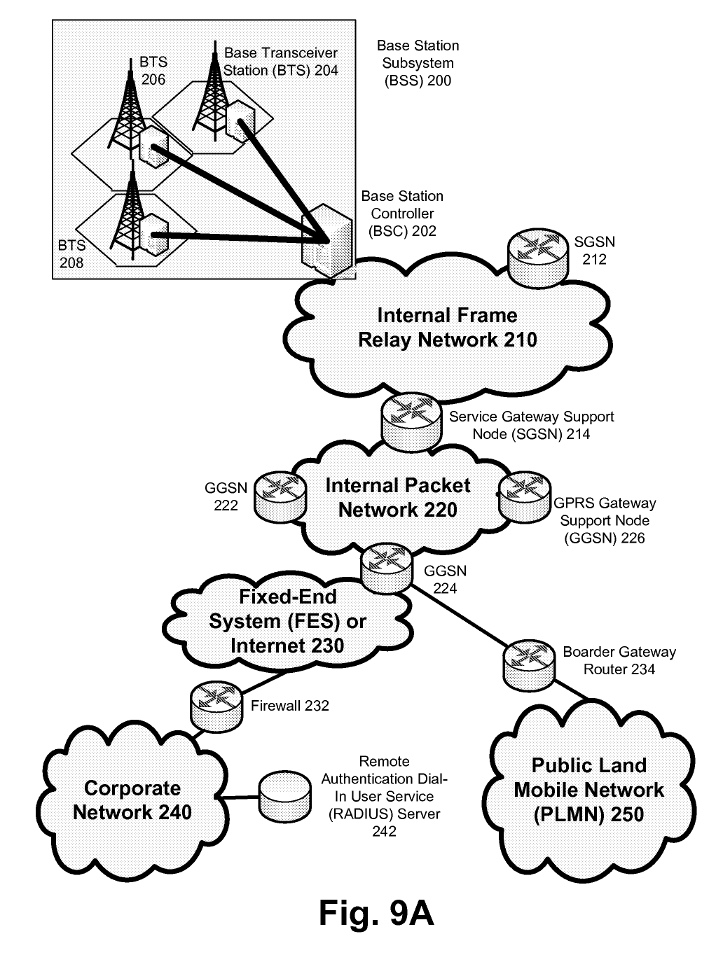

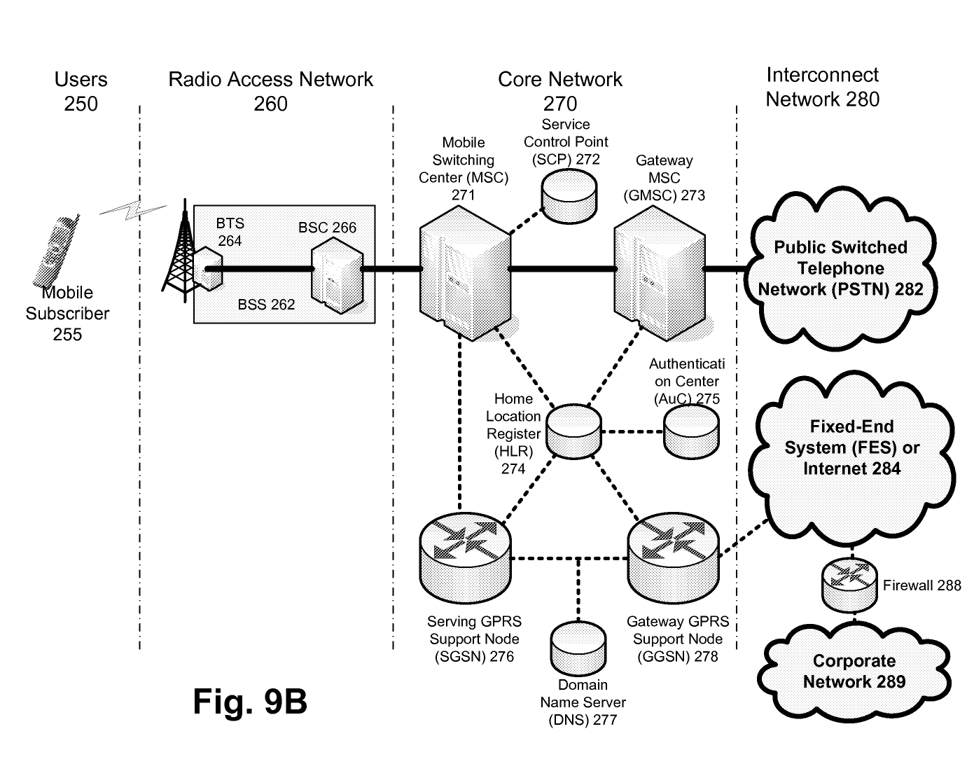

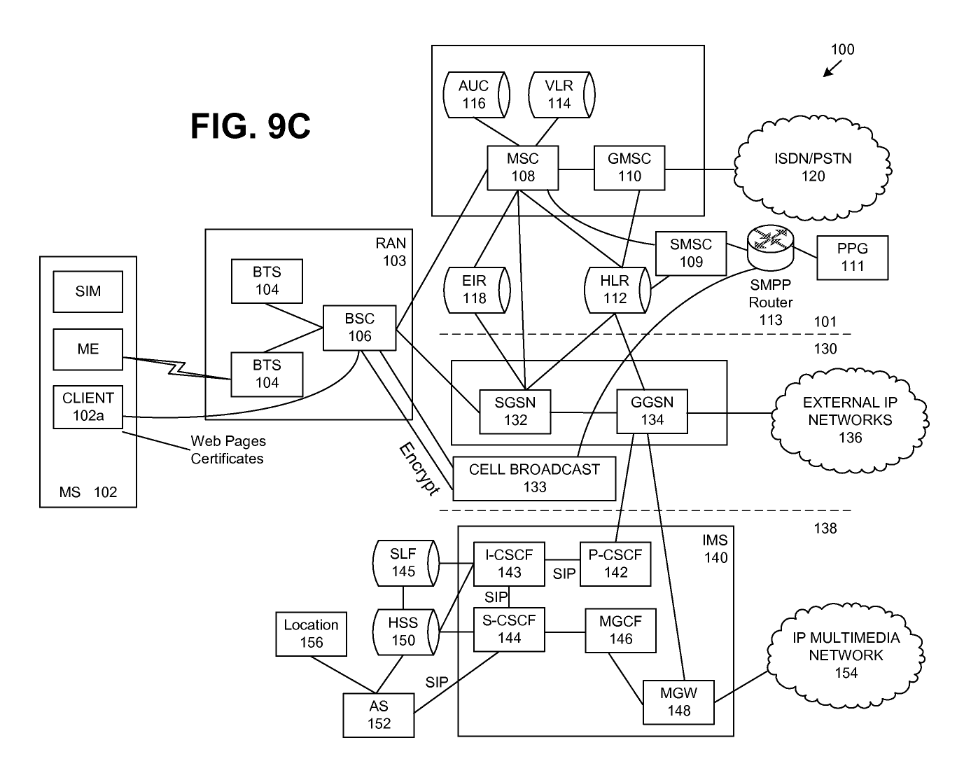

FIG. 9A depicts an overall block diagram of an exemplary packet-based mobile cellular network environment, such as a GPRS network, in which the invention may be practiced. In such an environment, there are a plurality of Base Station Subsystems (“BSS”) 200 (only one is shown), each of which comprises a Base Station Controller (“BSC”) 202 serving a plurality of Base Transceiver Stations (“BTS”) such as BTSs 204, 206, and 208. BTSs 204, 206, 208, etc. are the access points where users of packet-based mobile devices become connected to the wireless network. In exemplary fashion, the packet traffic originating from user devices is transported over the air interface to a BTS 208, and from the BTS 208 to the BSC 202. Base station subsystems, such as BSS 200, are a part of internal frame relay network 210 that may include Service GPRS Support Nodes (“SGSN”) such as SGSN 212 and 214. Each SGSN is in turn connected to an internal packet network 220 through which a SGSN 212, 214, etc. can route data packets to and from a plurality of gateway GPRS support nodes (GGSN) 222, 224, 226, etc. As illustrated, SGSN 214 and GGSNs 222, 224, and 226 are part of internal packet network 220. Gateway GPRS serving nodes 222, 224 and 226 mainly provide an interface to external Internet Protocol (“IP”) networks such as Public Land Mobile Network (“PLMN”) 250, corporate intranets 240, or Fixed-End System (“FES”) or the public Internet 230. As illustrated, subscriber corporate network 240 may be connected to GGSN 224 via firewall 232; and PLMN 250 is connected to GGSN 224 via boarder gateway router 234. The Remote Authentication Dial-In User Service (“RADIUS”) server 242 may be used for caller authentication when a user of a mobile cellular device calls corporate network 240.

Generally, there can be four different cell sizes in a GSM network—macro, micro, pico and umbrella cells. The coverage area of each cell is different in different environments. Macro cells can be regarded as cells where the base station antenna is installed in a mast or a building above average roof top level. Micro cells are cells whose antenna height is under average roof top level; they are typically used in urban areas. Pico cells are small cells having a diameter is a few dozen meters; they are mainly used indoors. On the other hand, umbrella cells are used to cover shadowed regions of smaller cells and fill in gaps in coverage between those cells.

FIG. 9B illustrates the architecture of a typical GPRS network as segmented into four groups: users 250, radio access network 260, core network 270, and interconnect network 280. Users 250 comprise a plurality of end users (though only mobile subscriber 255 is shown in FIG. 9B). Radio access network 260 comprises a plurality of base station subsystems such as BSSs 262, which include BTSs 264 and BSCs 266. Core network 270 comprises a host of various network elements. As illustrated here, core network 270 may comprise Mobile Switching Center (“MSC”) 271, Service Control Point (“SCP”) 272, gateway MSC 273, SGSN 276, Home Location Register (“HLR”) 274, Authentication Center (“AuC”) 275, Domain Name Server (“DNS”) 277, and GGSN 278. Interconnect network 280 also comprises a host of various networks and other network elements. As illustrated in FIG. 9B, interconnect network 280 comprises Public Switched Telephone Network (“PSTN”) 282, Fixed-End System (“FES”) or Internet 284, firewall 288, and Corporate Network 289.

A mobile switching center can be connected to a large number of base station controllers. At MSC 271, for instance, depending on the type of traffic, the traffic may be separated in that voice may be sent to Public Switched Telephone Network (“PSTN”) 282 through Gateway MSC (“GMSC”) 273, and/or data may be sent to SGSN 276, which then sends the data traffic to GGSN 278 for further forwarding.

When MSC 271 receives call traffic, for example, from BSC 266, it sends a query to a database hosted by SCP 272. The SCP 272 processes the request and issues a response to MSC 271 so that it may continue call processing as appropriate.

The HLR 274 is a centralized database for users to register to the GPRS network. HLR 274 stores static information about the subscribers such as the International Mobile Subscriber Identity (“IMSI”), subscribed services, and a key for authenticating the subscriber. HLR 274 also stores dynamic subscriber information such as the current location of the mobile subscriber. Associated with HLR 274 is AuC 275. AuC 275 is a database that contains the algorithms for authenticating subscribers and includes the associated keys for encryption to safeguard the user input for authentication.

In the following, depending on context, the term “mobile subscriber” sometimes refers either to the end user and sometimes to the actual portable device used by an end user of the mobile cellular service. When a mobile subscriber turns on his or her mobile device, the mobile device goes through an attach process by which the mobile device attaches to an SGSN of the GPRS network. In FIG. 9B, when mobile subscriber 255 initiates the attach process by turning on the network capabilities of the mobile device, an attach request is sent by mobile subscriber 255 to SGSN 276. The SGSN 276 queries another SGSN, to which mobile subscriber 255 was attached before, for the identity of mobile subscriber 255. Upon receiving the identity of mobile subscriber 255 from the other SGSN, SGSN 276 requests more information from mobile subscriber 255. This information is used to authenticate mobile subscriber 255 to SGSN 276 by HLR 274. Once verified, SGSN 276 sends a location update to HLR 274 indicating the change of location to a new SGSN, in this case SGSN 276. HLR 274 notifies the old SGSN, to which mobile subscriber 255 was attached before, to cancel the location process for mobile subscriber 255. HLR 274 then notifies SGSN 276 that the location update has been performed. At this time, SGSN 276 sends an Attach Accept message to mobile subscriber 255, which in turn sends an Attach Complete message to SGSN 276.

After attaching itself with the network, mobile subscriber 255 then goes through an authentication process. In the authentication process, SGSN 276 sends the authentication information to HLR 274, which sends information back to SGSN 276 based on the user profile that was part of the user's initial setup. The SGSN 276 then sends a request for authentication and ciphering to mobile subscriber 255. The mobile subscriber 255 uses an algorithm to send the user identification (ID) and password to SGSN 276. The SGSN 276 uses the same algorithm and compares the result. If a match occurs, SGSN 276 authenticates mobile subscriber 255.

Next, the mobile subscriber 255 establishes a user session with the destination network, corporate network 289, by going through a Packet Data Protocol (“PDP”) activation process. Briefly, in the process, mobile subscriber 255 requests access to the Access Point Name (“APN”), for example, UPS.com (e.g., which can be corporate network 279 in FIG. 3) and SGSN 276 receives the activation request from mobile subscriber 255. SGSN 276 then initiates a Domain Name Service (“DNS”) query to learn which GGSN node has access to the UPS.com APN. The DNS query is sent to the DNS server within the core network 270, such as DNS 277, which is provisioned to map to one or more GGSN nodes in the core network 270. Based on the APN, the mapped GGSN 278 can access the requested corporate network 279. The SGSN 276 then sends to GGSN 278 a Create Packet Data Protocol (“PDP”) Context Request message that contains necessary information. The GGSN 278 sends a Create PDP Context Response message to SGSN 276, which then sends an Activate PDP Context Accept message to mobile subscriber 255.

Once activated, data packets of the call made by mobile subscriber 255 can then go through radio access network 260, core network 270, and interconnect network 280, in particular fixed-end system or Internet 284 and firewall 288, to reach corporate network 289.

Thus, network elements that may implicate the functionality of the systems and methods for content management in accordance with the invention may include but are not limited to Gateway GPRS Support Node tables, Fixed End System router tables, firewall systems, VPN tunnels, and any number of other network elements as required by the particular digital network.

FIG. 9C shows yet another exemplary block diagram view of a GSM/GPRS/IP multimedia network architecture 100 in which the systems and methods for content management of the present invention may be incorporated. As illustrated, architecture 100 of FIG. 9C includes a GSM core network 101, a GPRS network 130 and an IP multimedia network 138. The GSM core network 101 includes a Mobile Station (MS) 102, at least one Base Transceiver Station (BTS) 104 and a Base Station Controller (BSC) 106. The MS 102 is physical equipment or Mobile Equipment (ME), such as a mobile phone or a laptop computer that is used by mobile subscribers, with a Subscriber identity Module (SIM). The SIM includes an International Mobile Subscriber Identity (IMSI), which is a unique identifier of a subscriber. The BTS 104 is physical equipment, such as a radio tower, that enables a radio interface to communicate with the MS. Each BTS may serve more than one MS. The BSC 106 manages radio resources, including the BTS. The BSC may be connected to several BTSs. The BSC and BTS components, in combination, are generally referred to as a base station (BSS) or radio access network (RAN) 103.

The GSM core network 101 also includes a Mobile Switching Center (MSC) 108, a Gateway Mobile Switching Center (GMSC) 110, a Home Location Register (HLR) 112, Visitor Location Register (VLR) 114, an Authentication Center (AuC) 118, and an Equipment Identity Register (EIR) 116. The MSC 108 performs a switching function for the network. The MSC also performs other functions, such as registration, authentication, location updating, handovers, and call routing. The GMSC 110 provides a gateway between the GSM network and other networks, such as an Integrated Services Digital Network (ISDN) or Public Switched Telephone Networks (PSTNs) 120. In other words, the GMSC 110 provides interworking functionality with external networks.

The HLR 112 is a database that contains administrative information regarding each subscriber registered in a corresponding GSM network. The HLR 112 also contains the current location of each MS. The VLR 114 is a database that contains selected administrative information from the HLR 112. The VLR contains information necessary for call control and provision of subscribed services for each MS currently located in a geographical area controlled by the VLR. The HLR 112 and the VLR 114, together with the MSC 108, provide the call routing and roaming capabilities of GSM. The AuC 116 provides the parameters needed for authentication and encryption functions. Such parameters allow verification of a subscriber's identity. The EIR 118 stores security-sensitive information about the mobile equipment.

A Short Message Service Center (SMSC) 109 allows one-to-one Short Message Service (SMS) messages to be sent to/from the MS 102. A Push Proxy Gateway (PPG) 111 is used to “push” (i.e., send without a synchronous request) content to the MS 102. The PPG 111 acts as a proxy between wired and wireless networks to facilitate pushing of data to the MS 102. A Short Message Peer to Peer (SMPP) protocol router 113 is provided to convert SMS-based SMPP messages to cell broadcast messages. SMPP is a protocol for exchanging SMS messages between SMS peer entities such as short message service centers. It is often used to allow third parties, e.g., content suppliers such as news organizations, to submit bulk messages.

To gain access to GSM services, such as speech, data, and short message service (SMS), the MS first registers with the network to indicate its current location by performing a location update and IMSI attach procedure. The MS 102 sends a location update including its current location information to the MSC/VLR, via the BTS 104 and the BSC 106. The location information is then sent to the MS's HLR. The HLR is updated with the location information received from the MSC/VLR. The location update also is performed when the MS moves to a new location area. Typically, the location update is periodically performed to update the database as location updating events occur.

The GPRS network 130 is logically implemented on the GSM core network architecture by introducing two packet-switching network nodes, a serving GPRS support node (SGSN) 132, a cell broadcast and a Gateway GPRS support node (GGSN) 134. The SGSN 132 is at the same hierarchical level as the MSC 108 in the GSM network. The SGSN controls the connection between the GPRS network and the MS 102. The SGSN also keeps track of individual MS's locations and security functions and access controls.

A Cell Broadcast Center (CBC) 133 communicates cell broadcast messages that are typically delivered to multiple users in a specified area. Cell Broadcast is one-to-many geographically focused service. It enables messages to be communicated to multiple mobile phone customers who are located within a given part of its network coverage area at the time the message is broadcast.

The GGSN 134 provides a gateway between the GPRS network and a public packet network (PDN) or other IP networks 136. That is, the GGSN provides interworking functionality with external networks, and sets up a logical link to the MS through the SGSN. When packet-switched data leaves the GPRS network, it is transferred to an external TCP-IP network 136, such as an X.25 network or the Internet. In order to access GPRS services, the MS first attaches itself to the GPRS network by performing an attach procedure. The MS then activates a packet data protocol (PDP) context, thus activating a packet communication session between the MS, the SGSN, and the GGSN.

In a GSM/GPRS network, GPRS services and GSM services can be used in parallel. The MS can operate in one three classes: class A, class B, and class C. A class A MS can attach to the network for both GPRS services and GSM services simultaneously. A class A MS also supports simultaneous operation of GPRS services and GSM services. For example, class A mobiles can receive GSM voice/data/SMS calls and GPRS data calls at the same time.

A class B MS can attach to the network for both GPRS services and GSM services simultaneously. However, a class B MS does not support simultaneous operation of the GPRS services and GSM services. That is, a class B MS can only use one of the two services at a given time.

A class C MS can attach for only one of the GPRS services and GSM services at a time. Simultaneous attachment and operation of GPRS services and GSM services is not possible with a class C MS.

A GPRS network 130 can be designed to operate in three network operation modes (NOM1, NOM2 and NOM3). A network operation mode of a GPRS network is indicated by a parameter in system information messages transmitted within a cell. The system information messages dictates a MS where to listen for paging messages and how signal towards the network. The network operation mode represents the capabilities of the GPRS network. In a NOM1 network, a MS can receive pages from a circuit switched domain (voice call) when engaged in a data call. The MS can suspend the data call or take both simultaneously, depending on the ability of the MS. In a NOM2 network, a MS may not received pages from a circuit switched domain when engaged in a data call, since the MS is receiving data and is not listening to a paging channel In a NOM3 network, a MS can monitor pages for a circuit switched network while received data and vise versa.

The IP multimedia network 138 was introduced with 3GPP Release 5, and includes an IP multimedia subsystem (IMS) 140 to provide rich multimedia services to end users. A representative set of the network entities within the IMS 140 are a call/session control function (CSCF), a media gateway control function (MGCF) 146, a media gateway (MGW) 148, and a master subscriber database, called a home subscriber server (HSS) 150. The HSS 150 may be common to the GSM network 101, the GPRS network 130 as well as the IP multimedia network 138.

The IP multimedia system 140 is built around the call/session control function, of which there are three types: an interrogating CSCF (I-CSCF) 143, a proxy CSCF (P-CSCF) 142, and a serving CSCF (S-CSCF) 144. The P-CSCF 142 is the MS's first point of contact with the IMS 140. The P-CSCF 142 forwards session initiation protocol (SIP) messages received from the MS to an SIP server in a home network (and vice versa) of the MS. The P-CSCF 142 may also modify an outgoing request according to a set of rules defined by the network operator (for example, address analysis and potential modification).

The I-CSCF 143, forms an entrance to a home network and hides the inner topology of the home network from other networks and provides flexibility for selecting an S-CSCF. The I-CSCF 143 may contact a subscriber location function (SLF) 145 to determine which HSS 150 to use for the particular subscriber, if multiple HSS's 150 are present. The S-CSCF 144 performs the session control services for the MS 102. This includes routing originating sessions to external networks and routing terminating sessions to visited networks. The S-CSCF 144 also decides whether an application server (AS) 152 is required to receive information on an incoming SIP session request to ensure appropriate service handling. This decision is based on information received from the HSS 150 (or other sources, such as an application server 152). The AS 152 also communicates to a location server 156 (e.g., a Gateway Mobile Location Center (GMLC)) that provides a position (e.g., latitude/longitude coordinates) of the MS 102.

The HSS 150 contains a subscriber profile and keeps track of which core network node is currently handling the subscriber. It also supports subscriber authentication and authorization functions (AAA). In networks with more than one HSS 150, a subscriber location function provides information on the HSS 150 that contains the profile of a given subscriber.

The MGCF 146 provides interworking functionality between SIP session control signaling from the IMS 140 and ISUP/BICC call control signaling from the external GSTN networks (not shown). It also controls the media gateway (MGW) 148 that provides user-plane interworking functionality (e.g., converting between AMR- and PCM-coded voice). The MGW 148 also communicates with other IP multimedia networks 154.

Push to Talk over Cellular (PoC) capable mobile phones register with the wireless network when the phones are in a predefined area (e.g., job site, etc.). When the mobile phones leave the area, they register with the network in their new location as being outside the predefined area. This registration, however, does not indicate the actual physical location of the mobile phones.

While the present invention has been described in connection with the embodiments shown in the various Figures, it is to be understood that other similar embodiments may be used or modifications and additions may be made to the described embodiment for performing the same function of the present invention without deviating therefrom. Thus, other variations and modifications to may be made without departing from the spirit or scope of the invention. For example, one skilled in the art will recognize that the present invention as described in the present application may apply to any environment, whether wired and/or wireless, and may be applied to any number of such devices connected to the system via at least one communications network and/or interacting across the network. Therefore, the present invention should not be limited to any single embodiment, but rather should be construed in breadth and scope in accordance with the appended claims.

What is claimed is:

1. A method for making a purchase via a networked portable device using keywords via a service of a network, comprising:
receiving setup information, wherein the setup information includes at least one of (a) payment information, (b) user purchasing decision information or (c) at least one keyword for at least one item related to a user purchasing decision;
transmitting the setup information to the service;
receiving buy information via a user interface of the networked portable device, wherein the buy information includes at least one keyword of said at least one keyword and a purchase command indicating a desire to purchase at least one item of said at least one item; and
transmitting the buy information to the service, whereby the service automatically initiates a purchase of the at least one item of said at least one item based on at least the setup information.

2. The method of claim 1, further comprising:
enabling a user to take at least one pre-defined action from a list of options including an option for the receiving of the buy information.

3. The method of claim 1, wherein the receiving includes receiving buy information for purchasing at least one item related to at least one set of digital content.

4. The method of claim 3, wherein the receiving includes receiving buy information for purchasing at least one item related to at least one digital advertisement.

5. The method of claim 1, further including:
receiving a request for acknowledgement by the networked portable device from the service.

6. The method of claim 5, further including:
receiving acknowledgement information via the user interface of the networked portable device in response to the request for acknowledgement in order to confirm the purchase command.

7. The method of claim 1, further including:
automatically initiating a charge by the service according to the payment information.

8. The method of claim 1, further comprising:
transmitting transaction information to a third party, wherein the transaction information includes at least one record of the purchase of the at least one item of said at least one item.

9. The method of claim 8, wherein the transmitting of transaction information includes transmitting transaction information to a vendor of the at least one item of said at least one item.

10. The method of claim 1, wherein the transmitting the buy information includes transmitting a Short Message Service (SMS) message from the user.

11. A method for managing digital content via a service of a network, comprising:
first transmitting, to a service for storage in at least one database, a reference to digital content and at least one content keyword for association with the digital content referred to by the reference;
second transmitting, to the service, at least one user keyword entered by a user and presenting to the user data representative of at least one set of digital content retrieved from the at least one database based on the at least one user keyword and a configuration associated with a user;
selecting a purchase action for purchasing the at least one set of digital content; and
transmitting information representing the purchase action to the service for performing the purchasing.

12. The method of claim 11, wherein the transmitting of information includes transmitting payment information included in the configuration associated with the user.

13. The method of claim 11, wherein the selecting includes automatically selecting the purchase action for purchasing the at least one set of digital content based on a type of content included in the at least one set of digital content.

14. The method of claim 11, wherein the second transmitting includes transmitting an action command to the service that causes the service to modify the at least one set of digital content prior to selecting the purchase action.

15. The method of claim 11, wherein the selecting includes selecting the purchase action from a list of options for taking a pre-defined action with respect to the at least one set of digital content.

16. A service for managing digital content via a service of a network, comprising:
at least one digital content database including digital content and at least one content keyword associated with the digital content;
at least one user database including user configuration information for a set of users that use the service;
a user keyword parsing component that receives at least one user keyword from a user and retrieves at least one set of digital content from the at least one database based on the at least one user keyword and a configuration associated with the user;
an interface component that receives an indication of a payment action selectable by the user for initiating a purchase of the at least one set of digital content based on payment information included in the configuration; and
a service component that initiates the payment action when selected by the user.

17. The service of claim 16, wherein the interface component receives the indication of the payment action from a menu of options including an option for purchasing at least one item related to the at least one set of digital content.

18. The service of claim 16, wherein the service component automatically requests acknowledgement of the payment action from the user prior to completing the purchase of the at least one set of digital content.

19. The service of claim 16, wherein the user keyword parsing component further receives an action command from a user of the service and, in response to receiving the action command, modifies the at least one set of digital content prior to completing the purchase.

20. The service of claim 16, wherein the at least one digital content database includes digital content represented as a reference to the digital content.
